(19) United States
(12) Patent Application Publication
(10) Pub. No.: US 2007/0077928 A1
(43) Pub. Date: Apr. 5, 2007

(54) Handoff system and method in communication system with smart antenna

(75) Inventors: Jong-In Kim, Seoul (KR); Young-Hoon Kwon, Soongnam-si (KR); Soon-Young Yoon, Seoul (KR); Sang-Hoon Sung, Suwon-si (KR)

Correspondence Address: THE FARRELL LAW FIRM, 333 EARLE OVINGTON BOULEVARD., SUITE 701, UNIONDALE, NY, 11553, US

(73) Assignee: Samsung Electronics Co., Ltd., Suwon-si (KR)

(21) Appl. No.: 11/524,710

(22) Filed: Sep. 21, 2006

(30) Foreign Application Priority Data
Sep. 21, 2005 (KR) 2005/87849

(51) Int. Cl. H04Q 7/20

(52) U.S. Cl. 455/436

(57) ABSTRACT

Disclosed are a handoff system and a handoff method in a communication system with a smart antenna. In a method for performing handoff in a communication system including BSs which have different antenna structures, neighbor BS information including antennas structure information of neighbor BSs is received from a serving BS, a handoff threshold value is set according to the received neighbor BS information, and a difference between pilot strengths of the neighbor BSs and that of the serving BS is compared with the set handoff threshold value to thereby determine whether to perform the handoff.

### PRIORITY

This application claims priority to applications filed in the Korean Industrial Property Office on Sep. 21, 2005, and assigned Serial No. 2005-87849, the contents of which are incorporated herein by reference.

### BACKGROUND OF THE INVENTION

1. Field of the Invention

The present invention relates to a system and a method for supporting a handoff in a communication system, and more particularly to a system and a method for supporting a handoff in a communication system including a Base Station (BS) with a smart antenna.

2. Description of the Related Art

In general, a communication system supports a procedure called a handoff in order to ensure that a Mobile Station (MS) freely travels between cells during a call. Reference will now be made to the handoff with reference to FIG. 1.

FIG. 1 illustrates a handoff procedure in a common communication system.

Referring to FIG. 1, a handoff may be generally defined as follows:

A handoff refers to a function of maintaining a call without interruption by automatically switching a traffic channel for a given subscriber, for example, an MS 101 when the MS 101 moves from a specific wireless communication area, for example, Cell 1 102, in which the MS 101 is currently located, to another wireless communication area, for example, Cell 2 103, in a communication system.

In addition, the above-mentioned communication system applies smart antenna technology in an effort to increase the coverage and capacity of a BS. Smart antenna technology refers to technology for converging radio waves on a desired subscriber and lowering interference signals from other subscribers during transmission/reception, thereby improving communication quality without increasing the number of BSs. That is, smart antenna technology has recently been commercialized for increasing the coverage and capacity of a BS by performing beam forming only into a direction of a specific area through a smart antenna in a communication system. Particularly, smart antennas have been preferentially disposed in BSs, such as hot spots, which require an increase in coverage and capacity. Reference will now be made to a system, to which such a smart antenna is applied, with reference to FIG. 2.

FIG. 2 illustrates an example of a mixed system which includes an ordinary BS and a BS with a smart antenna in a common communication system.

Referring to FIG. 2, a communication system includes an MS 201, a serving BS 202 in which the MS 201 is currently located and to which the MS 201 currently connects, and a target BS 203 to which the MS desires to move and connect. Hereinafter, a description will be given for a case where the serving BS 202 is not provided with a smart antenna and the target BS 203 is provided with a smart antenna, by way of example.

As illustrated in FIG. 2, there may be a situation where the MS 201 moves from an ordinary BS without a smart antenna (Normal BS), that is, the serving BS 202, to a BS with a smart antenna (SA BS), that is, the target BS 203. On the contrary, there may be a situation where the MS 201 moves from the SA BS 203 to a Normal BS 202.

In these situations, since the Normal BS 202 and the SA BS 203 have different coverage areas, it is very inefficient for the MS 201 to wholly apply the existing handoff procedure as described in FIG. 1, which is performed when the MS 201 moves between Normal BSs.

That is, in the above-mentioned system in which a Normal BS and an SA BS are mixed, for example, in a system in which a target BS is an SA BS and a serving BS is a Normal BS, if a handoff is performed at the same point as a point at which a handoff is performed when the target BS is a Normal BS, there is a problem in that coverage gain provided by a smart antenna of the SA BS is not efficiently utilized.

Therefore, there is a need to provide a method for an efficient handoff between an SA BS and a Normal BS. That is, when the MS 201 performs a handoff from a serving BS, in which the MS 201 is currently, located, to a target BS, the MS 201 is required to consider whether or not the serving BS and the target BS are provided with smart antennas and to correspondingly perform the handoff.

### SUMMARY OF THE INVENTION

Accordingly, the present invention has been made to solve at least the above-mentioned problems occurring in the prior art, and an object of the present invention is to provide an efficient handoff system and an efficient handoff method in a communication system in which different antenna schemes are mixed.

A further object of the present invention is to provide an efficient handoff system and an efficient handoff method in a communication system in which a Normal BS and an SA BS are mixed.

A further object of the present invention is to provide a handoff system and a handoff method in a communication system, which can efficiently set up cell boundary areas by adjusting a hysteresis parameter adaptively to system situations.

A further object of the present invention is to provide an efficient handoff system and an efficient handoff method in a communication system, in which whether or not serving BSs and target BSs use smart antennas is determined, and a handoff is performed correspondingly.

In order to accomplish these objects, in accordance with one aspect of the present invention, there is provided a method for performing a handoff in a communication system including BSs which have different antenna structures, the method including receiving neighbor BS information, which includes antenna structure information of neighbor BSs, from a serving BS; setting a handoff threshold value according to the received neighbor BS information; and comparing a difference between pilot strengths of the neighbor BSs and that of the serving BS with the set handoff threshold value to thereby determine whether to perform the handoff.

In accordance with another aspect of the present invention, there is provided a system for performing a handoff in a communication system including BSs which have different antenna structures, the system including a BS for transmitting neighbor BS information for handoff determination, which includes antenna structure information of neighbor BSs; and an MS for setting a handoff threshold value corresponding to the antenna structure information of the neighbor BSs included in the received neighbor BS information, and comparing a difference between pilot strengths of the neighbor BSs and that of the serving BS with the set handoff threshold value to thereby determine whether to perform the handoff.

### BRIEF DESCRIPTION OF THE DRAWINGS

The above and other objects, features and advantages of the present invention will be more apparent from the following detailed description taken in conjunction with the accompanying drawings, in which:

FIG. 1 is a diagram for explaining a handoff procedure in a common communication system;

FIG. 2 is a diagram illustrating an example of a mixed system which includes a Normal BS and an SA BS in a common communication system;

FIG. 3 illustrates a handoff procedure in a common communication system;

FIG. 4 is a graph explaining how a handoff is performed according to a hysteresis parameter in a common communication system;

FIG. 5 is a graph explaining how a handoff is performed according to a hysteresis parameter in a communication system in accordance with the present invention; and

FIG. 6 illustrates a handoff procedure in a communication system in accordance with the present invention.

### DETAILED DESCRIPTION OF THE PREFERRED EMBODIMENT

Hereinafter, preferred embodiments of the present invention will be described with reference to the accompanying drawings. It should be noted that similar components are designated by similar reference numerals although they are illustrated in different drawings. Also, in the following description, a detailed description of known functions and configurations incorporated herein will be omitted when it may obscure the subject matter of the present invention.

The present invention provides a handoff system and a handoff method in a communication system. In particular, the present invention provides an efficient handoff scheme in a communication system in which a Normal BS and an SA BS are mixed.

In such a communication system, the Normal BS and the SA BS support different coverage areas. Thus, it has been very inefficient for an MS to wholly apply the existing handoff procedure which is performed when the MS moves between Normal BSs.

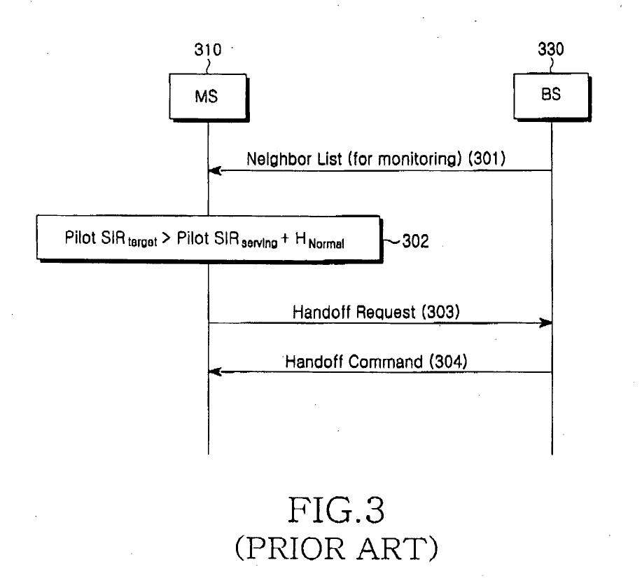

Hence, there is a need to provide a method for an efficient handoff between the Normal BS and the SA BS. Corresponding to this, when the MS performs a handoff from a serving BS, to which the MS currently connects, to a target BS, the MS must consider whether the Normal BS and the SA BS are provided with smart antennas. Hereinafter, a handoff method in a common communication system will be described with reference to FIG. 3.

FIG. 3 illustrates a handoff procedure in a common communication system.

Referring to FIG. 3, in order to perform a handoff, a BS 330 transmits a neighbor list consisting of BSs, the pilot strengths of which an MS 310 is to measure as a measure of a handoff, to an MS 310 (step 301).

Here, the neighbor list may be created by applying various criteria, but a detailed description thereof will be omitted because it is beyond the scope of the present invention.

Next, the MS 310, having received the neighbor list from the BS 330, determines whether to perform the handoff (step 302). When a predetermined criterion as given below in Equation (1) is satisfied in step 302, the MS 310 transmits a handoff request message to the BS 330 (step 303). If the BS 330 determines handoff of the MS 310 in response to the handoff request from the MS 310, it instructs the MS 310 to perform the handoff by transmitting a handoff command message to the MS 310 (step 304).

In step 302, the predetermined criteria based on which the MS determines to perform the handoff can be expressed by the following equation:
Pilot SIR_{target}>Pilot SIR_{serving}+H_{Normal} (1)

In Equation (1), Pilot SIR_{target} and Pilot SIR_{serving} denote pilot Signal to Interference Ratios (SIR) of target and serving BSs, respectively. It is obvious that other measures such as a Signal to Interference & Noise Ratio (SINR), a Carrier to Interference & Noise Ratio (CINR), etc. may be used in addition to the SIR. H_{Normal} denotes a margin for preventing an unnecessary handoff, that is, a pingpong phenomenon. In other words, H_{Normal} denotes hysteresis.

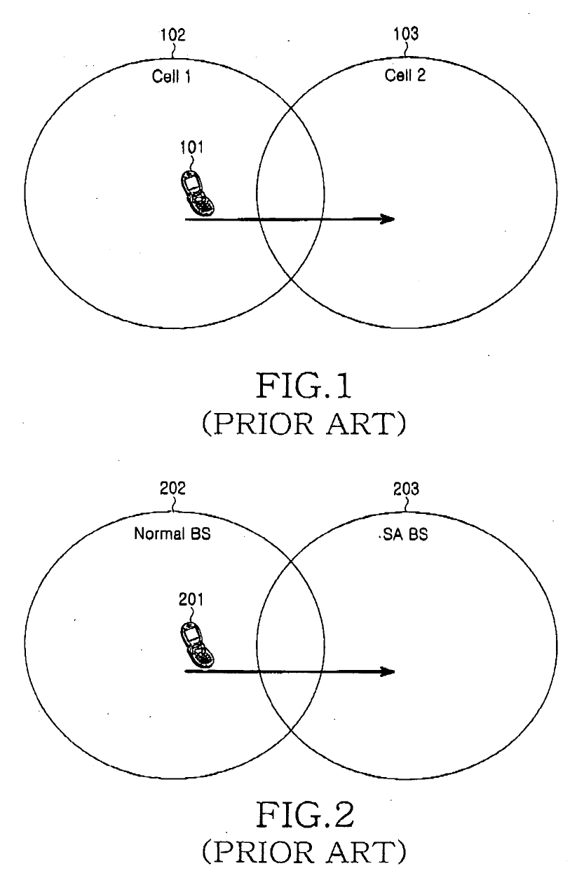

The hysteresis for preventing the pingpong phenomenon acts as a parameter for determining cell boundaries between BSs in an actual communication system. Let us suppose that an MS is moving from a serving BS, to which the MS currently connects, to a target BS, at which the MS aims a handoff, as illustrated in FIG. 1. In this situation, when the hysteresis is great, a point of time of a handoff is delayed. As a result of this, the cell coverage of the serving BS expands to the extent that the handoff is delayed. In contrast with this, when the hysteresis is small, a point of time of a handoff is advanced. As a result of this, the cell coverage of the serving BS decreases to the extent that the time for handoff is advanced.

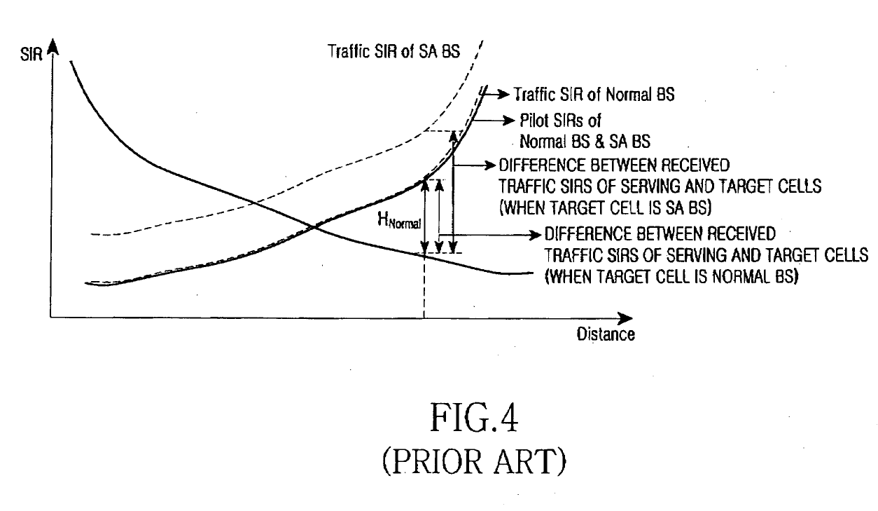

Thus, if there occurs a situation where the MS moves from a Normal BS to an SA BS, the traffic signal coverage between the serving BS and the target BS becomes asymmetric. If the MS moves in the opposite direction to the above situation, the traffic signal coverage between the serving BS and the target BS also becomes asymmetric. When the traffic signal coverage is asymmetric, the hysteresis parameter must be adjusted. Hereinafter, a description will be given of a general case of controlling the hysteresis parameter with reference to FIG. 4.

FIG. 4 explains how a handoff is performed according to a hysteresis parameter in a common communication system.

Referring to FIG. 4, the SIRs of pilot and traffic channels (hereinafter pilot SIR and traffic SIR, respectively) received from serving and target BSs vary while an MS moves from the serving BS to the target BS. FIG. 4 illustrates how the SIRs vary with a distance.

As seen from FIG. 4, when both the serving BS and the target BS are Normal BSs, the pilot SIRs received from both BSs are similar in magnitude to the traffic SIRs. On the contrary, when the target BS is an SA BS, it is noted that the pilot SIR received from the target BS is lower in magnitude than the traffic SIR. This is because coverage gain provided by a smart antenna is not reflected on a pilot signal.

Thus, if the MS performs a handoff at the same point as a point at which a handoff is performed when the target BS is a Normal BS, even in a case where the target BS is an SA BS, the result is that the coverage gain provided by a smart antenna is not efficiently utilized.

Therefore, the present invention provides a scheme which enables a handoff to be efficiently performed by considering whether serving and target BSs are provided with smart antennas when an MS moves from the serving BS to the target BS. Reference will now be made in detail to a construction of the present invention with reference to the accompanying drawings.

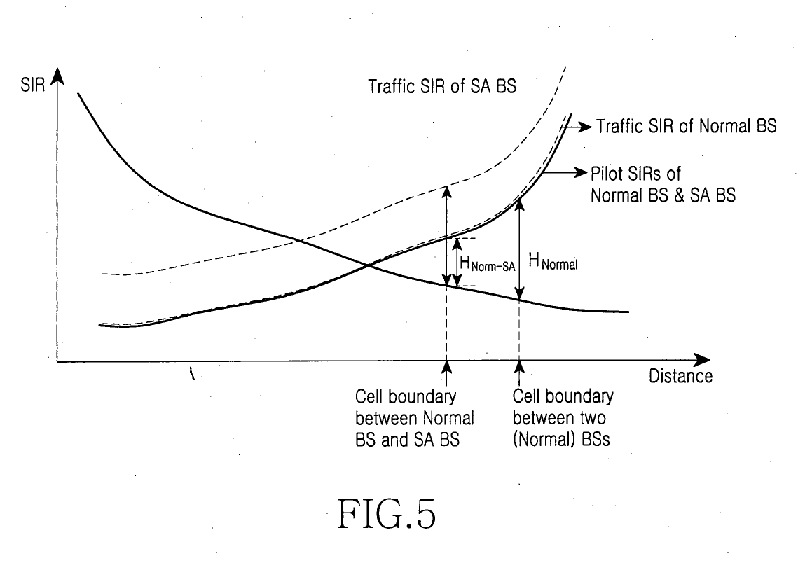

FIG. 5 explains how a handoff is performed according to a hysteresis parameter in a communication system in accordance with the present invention.

Referring to FIG. 5, it shows changes in the pilot and traffic SIRs received from serving and target BSs while an MS moves from the serving BS to the target BS. FIG. 5 also assumes a situation where the MS moves from Cell 1 of the serving BS to Cell 2 of the target BS.

When the serving BS is a Normal BS and the target BS is an SA BS, actual traffic signal coverage becomes larger as compared with when the target BS is a Normal BS, as illustrated in FIG. 5. Thus, the hysteresis is preferably set to a lower value H_{Norm-SA}, as illustrated in FIG. 5, such that a handoff is performed at a point of time when a difference between the traffic SIRs received from the serving and target BSs is the same in magnitude as the hysteresis H_{Normal}, which is used for determining a handoff between Normal BSs.

To this end, the MS is preferably constructed in such a manner that it periodically measures pilot SIRs received from BSs included in a neighbor list by using existing ordinary techniques.

In addition, in the present invention, the hysteresis parameter is adaptively adjusted to system situations in supporting a handoff between a Normal BS and an SA BS, as described above in connection with FIG. 5. Here, an algorithm for adjusting the hysteresis parameter may be implemented by transmitting the following hysteresis information according to system situations from a BS to an MS:
information indicating whether BSs of a neighbor list are SA BSs,
hysteresis H_{Normal} to be used in a handoff between Normal BSs,
hysteresis H_{Normal-SA} to be used in a handoff from a Normal BS to an SA BS,
hysteresis H_{SA-Normal} to be used in a handoff from an SA BS to a Normal BS,
hysteresis H_{SA} to be used in a handoff between SA BSs.

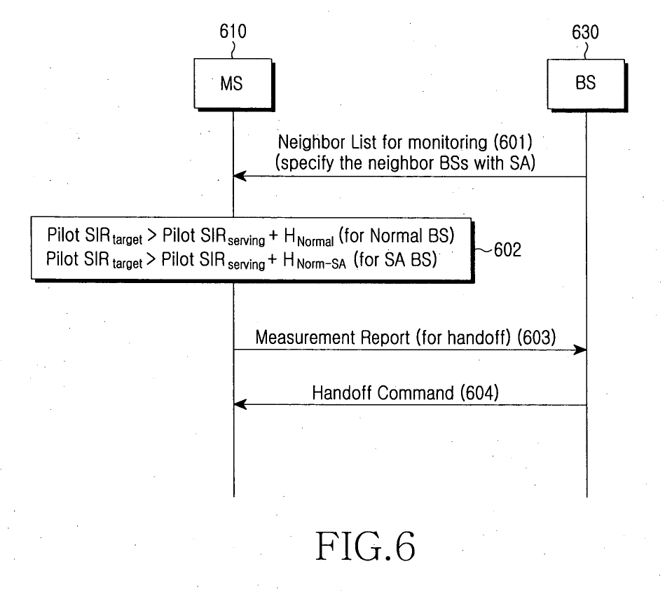

Reference will now be made to a procedure of transmitting such information with reference to FIG. 6.

FIG. 6 illustrates a handoff procedure in a communication system according to the present invention.

Referring to FIG. 6, in order to perform a handoff, a BS 630 transmits a neighbor list consisting of BSs, the pilot strengths of which an MS 610 is to measure as a measure of a handoff, to an MS 610 (step 601). Here, when the BS 630 transmits the neighbor list, it further includes therein information on whether the BSs included in the neighbor list are provided with smart antennas, that is, information on whether there are SA BSs among the BSs included in the neighbor list. Such information is herein referred to as antenna structure information.

Along with the antenna structure information, the neighbor list transmitted by the BS 630 further includes information on hysteresis to be used when the MS 610 performs a handoff from a Normal BS to an SA BS, and information on hysteresis to be used when the MS 610 performs a handoff in the opposite direction, that is, from an SA BS to a Normal BS.

In another embodiment of the present invention, the BS 630 does not transmit the information on hysteresis to the MS 610, but the MS 610 may store the information on hysteresis. That is, it is obvious that the MS 610 may use hysteresis, which is selected corresponding to the antenna structure information received from the BS 630, from among the information on hysteresis stored therein.

The MS 610, having received the neighbor list from the BS 630, then determines whether to perform a handoff (step 602). Here, based on the information included in the neighbor list, the MS 610 determines whether the handoff to be performed is a handoff from a Normal BS to an SA BS, a handoff from an SA BS to a Normal BS, or a handoff between SA BSs.

Such determination on a handoff is made using the following equations as given below in Equations (2), (3) and (4). That is, based on the information received from the BS 630, the MS determines, using the hysteresis H_{Normal-SA}, if it performs a handoff from a Normal BS to an SA BS, determines, using the hysteresis H_{SA-Normal}, if it performs a handoff from an SA BS to a Normal BS, and determines, using the hysteresis H_{SA}, if it performs a handoff between SA BSs:
Pilot SIR_{target}>Pilot SIR_{serving}+H_{Normal-SA} (2)
Pilot SIR_{target}>Pilot SIR_{serving}+H_{SA-Normal} (3)
Pilot SIR_{target}>Pilot SIR_{serving}+H_{SA} (4)

Next, in step 602, the MS 610 determines a corresponding handoff through Equations (2), (3) and (4), and transmits a handoff request message to the BS 630 (step 603). If the BS 630 determines the handoff of the MS 610 in response to the handoff request from the MS 610, it instructs the MS 610 to perform the handoff by transmitting a handoff command message to the MS 610 (step 604).

As described above, according to the inventive system and method, an efficient handoff system and an efficient handoff method can be provided in a system in which different antenna schemes are mixed. Further, by determining whether serving and target BSs use smart antennas and performing a handoff correspondingly, efficient handoff can be provided in a communication system in which a Normal BS and an SA BS are mixed. Further, in a handoff between a Normal BS and an SA BS, cell boundary areas can be efficiently set up by adaptively adjusting a hysteresis parameter to system situations.

While the invention has been shown and described with reference to certain preferred embodiments thereof, it will be understood by those skilled in the art that various changes in form and details may be made therein without departing from the spirit and scope of the invention as defined by the appended claims and equivalents thereof.

What is claimed is:

1. A method for performing a handoff in a communication system including base station(BS)s which have different antenna structures, the method comprising the steps of:
receiving neighbor BS information, which includes antenna structure information of neighbor BSs, from a serving BS;
setting a handoff threshold value according to the received neighbor BS information; and
comparing a difference between pilot strengths of the neighbor BSs and that of the serving BS with the set handoff threshold value to thereby determine whether to perform the handoff.

2. The method as claimed in claim 1, wherein the antenna structure information includes information on whether the neighbor BSs are provided with smart antennas.

3. The method as claimed in claim 1, wherein, in the setting step, one handoff threshold value corresponding to the neighbor BS information is selected from among a plurality of stored handoff threshold values.

4. The method as claimed in claim 3, wherein the stored handoff threshold values includes at least one of a threshold value to be used in a handoff between BSs without a smart antenna, a threshold value to be used in a handoff from a BS without a smart antenna to a BS with a smart antenna, a threshold value to be used in a handoff from a BS with a smart antenna to a BS without a smart antenna, and a threshold value to be used in a handoff between BSs with a smart antenna.

5. The method as claimed in claim 1, wherein, in the setting step, when the serving BS is a BS without a smart antenna and a neighbor BS is a BS with a smart antenna according to the neighbor BS information, the handoff threshold value is set to a lower value than a threshold value of a handoff between BSs without a smart antenna.

6. The method as claimed in claim 1, wherein, in the setting step, when the serving BS is a BS with a smart antenna and a neighbor BS is a BS without a smart antenna according to the neighbor BS information, the threshold value is set to a greater value than a threshold value of a handoff between BSs without a smart antenna.

7. The method as claimed in claim 1, wherein the antenna structure information includes a handoff threshold value to be used when a mobile station(MS) performs a handoff between BSs without a smart antenna and, corresponding to the handoff threshold value, the MS performs the handoff between BSs without a smart antenna.

8. The method as claimed in claim 1, wherein the antenna structure information includes a handoff threshold value to be used when a mobile station(MS) performs a handoff from a BS without a smart antenna to a BS with a smart antenna and, corresponding to the handoff threshold value, the MS performs the handoff from a BS without a smart antenna to a BS with a smart antenna.

9. The method as claimed in claim 1, wherein the antenna structure information includes a handoff threshold value to be used when a mobile station(MS) performs a handoff from a BS with a smart antenna to a BS without a smart antenna and, corresponding to the handoff threshold value, the MS performs the handoff from a BS with a smart antenna to a BS without a smart antenna.

10. The method as claimed in claim 1, wherein the antenna structure information includes a handoff threshold value to be used when a mobile station(MS) performs a handoff between BSs with a smart antenna and, corresponding to the handoff threshold value, the MS performs the handoff between BSs with a smart antenna.

11. The method as claimed in claim 1, further comprising transmitting a request for the handoff to the serving BS after having determined whether to perform the handoff.

12. A system for performing a handoff in a communication system including base station(BS)s which have different antenna structures, the system comprising:
a BS for transmitting neighbor BS information for handoff determination, which includes antenna structure information of neighbor BSs; and
a mobile station(MS) for setting a handoff threshold value corresponding to the antenna structure information of the neighbor BSs included in the received neighbor BS information, and comparing a difference between pilot strengths of the neighbor BSs and that of the serving BS with the set handoff threshold value to thereby determine whether to perform the handoff.

13. The system as claimed in claim 12, wherein the antenna structure information includes information on whether the neighbor BSs are provided with smart antennas.

14. The system as claimed in claim 12, wherein the MS selects one handoff threshold value corresponding to the neighbor BS information from among a plurality of stored handoff threshold values, and then sets the handoff threshold value to the selected handoff threshold value.

15. The system as claimed in claim 14, wherein the stored handoff threshold values includes at least one of a threshold value to be used in a handoff between BSs without a smart antenna, a threshold value to be used in a handoff from a BS without a smart antenna to a BS with a smart antenna, a threshold value to be used in a handoff from a BS with a smart antenna to a BS without a smart antenna, and a threshold value to be used in a handoff between BSs with a smart antenna.

16. The system as claimed in claim 12, wherein, when the serving BS is a BS without a smart antenna and a neighbor BS is a BS with a smart antenna according to the neighbor BS information, the MS sets the handoff threshold value to a lower value than a threshold value of a handoff between BSs without a smart antenna.

17. The system as claimed in claim 12, wherein, when the serving BS is a BS with a smart antenna and a neighbor BS is a BS without a smart antenna according to the neighbor BS information, the MS sets the handoff threshold value to a greater value than a threshold value of a handoff between BSs without a smart antenna.

18. The system as claimed in claim 12, wherein the antenna structure information includes a handoff threshold value to be used when the MS performs a handoff between BSs without a smart antenna and, corresponding to the handoff threshold value, the MS performs the handoff between BSs without a smart antenna.

19. The system as claimed in claim 12, wherein the antenna structure information includes a handoff threshold value to be used when the MS performs a handoff from a BS without a smart antenna to a BS with a smart antenna and, corresponding to the handoff threshold value, the MS performs the handoff from a BS without a smart antenna to a BS with a smart antenna.

20. The system as claimed in claim 12, wherein the antenna structure information includes a handoff threshold value to be used when the MS performs a handoff from a BS with a smart antenna to a BS with a smart antenna and, corresponding to the handoff threshold value, the MS performs the handoff from a BS with a smart antenna to a BS without a smart antenna.

21. The system as claimed in claim 12, wherein the antenna structure information includes a handoff threshold value to be used when the MS performs a handoff between BSs with a smart antenna and, corresponding to the handoff threshold value, the MS performs the handoff between BSs with a smart antenna.

22. The system as claimed in claim 12, wherein, if a determination on whether to perform the handoff has been made, the MS further transmits a request for the handoff corresponding to the determination to the serving BS.
